(19) United States
(12) Patent Application Publication
(10) Pub. No.: US 2010/0319788 A1
(43) Pub. Date: Dec. 23, 2010

(54) SEPARATING LIQUID SHUT-OFF FOR AMMONIA VAPOR TRANSFER SYSTEM

(76) Inventor: David P. Ward, Dallas, TX (US)

Correspondence Address: Daniel V. Thompson;The Law Offices Of Daniel V. Thompson P.C., 9304 Forest Lane,, Suite N253, Dallas, TX, 75243, US

(21) Appl. No.: 12/488,530

(22) Filed: Jun. 20, 2009

(51) Int. Cl. F16K 24/04

(52) U.S. Cl. 137/202

(57) ABSTRACT

A separating liquid shut-off for an ammonia vapor transfer system has a centrifugal liquid-vapor separator and a float-actuated shut-off valve.

### BACKGROUND OF THE INVENTION

This invention relates to pressurized systems used in the transfer of product to and from pressure vessels. More particularly, the invention relates to equipment used in the transfer of agricultural ammonia from storage tanks and wagon-mounted nurse tanks, and provides a safety device for separating liquid from a mixed flow of liquid and gas and shutting off the flow if excessive liquid is present.

Liquid anhydrous ammonia (NH,) has long been used as a fertilizer for corn, grains and other crops. The typical ammonia application system consists of a nurse tank trailed behind a tool bar which is attached to a tractor. The nurse tank is a trailer-mounted pressure vessel which contains the ammonia in its liquid state. The ammonia flows through a hose from the tank to one or more dividing manifolds, and finally through suitable hoses to the applicator knives which inject the ammonia into the soil. At the end of ammonia season, empty nurse tanks need to be completely evacuated for storage. While most tanks hold only remnant vapor to be disposed of, some may have liquid ammonia in them as well.

The problem is that even a small amount of liquid ammonia will damage the vapor transfer pumps commonly in use. There needs to be a simple liquid separator at the point of the transfer pump to separate out the small amounts of liquid expected, but also capable of shutting off if an excessive amount of liquid is encountered.

### SUMMARY OF THE INVENTION

A separating liquid shut-off for an ammonia vapor transfer system has a centrifugal liquid-vapor separator and a float-actuated shut-off valve.

### BRIEF DESCRIPTION OF THE DRAWINGS

A more complete understanding of the invention and its advantages will be apparent from the Detailed Description taken in conjunction with the accompanying Drawings, in which:

FIG. 1 is a side view of an ammonia transfer system and two nurse tanks, which is the environment of the present invention;

FIG. 2 is a side view of the Separating Liquid Shut-off of the present invention;

FIG. 3 is a side view similar to FIG. 2 rotated ninety degrees

FIG. 4 is a sectional view taken along lines 4-4 of FIG. 3;

FIG. 5 is a perspective view of the float used in the invention;

FIG. 6 is a perspective view of the bottom member and float used in the invention;

FIG. 7 is a top view of the valve used in the invention;

FIG. 8 is a perspective view of the valve;

FIG. 9 is an enlarged portion of a view similar to FIG. 4 with the valve in the open position; and

FIG. 10 is an exploded view of the Separating Liquid Shut-off.

### DETAILED DESCRIPTION

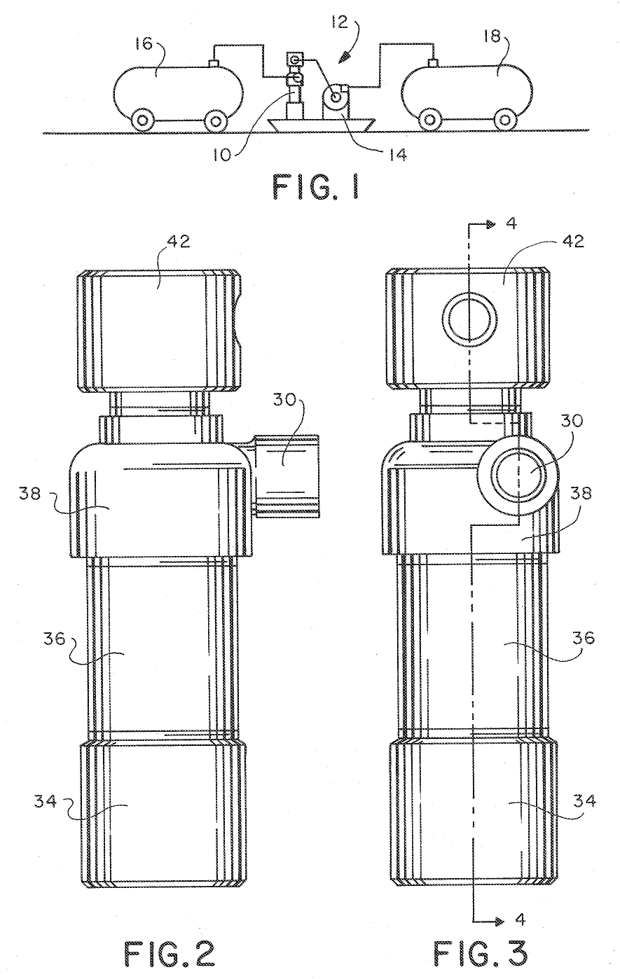

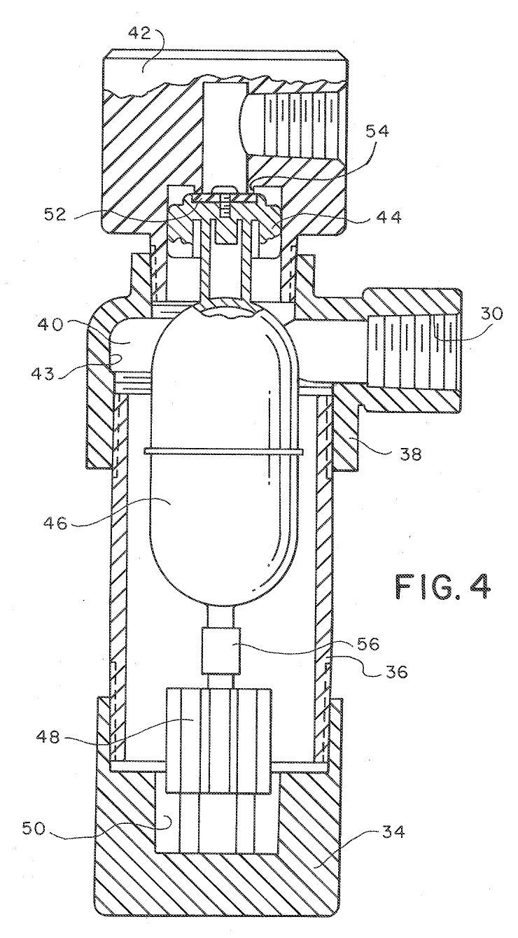

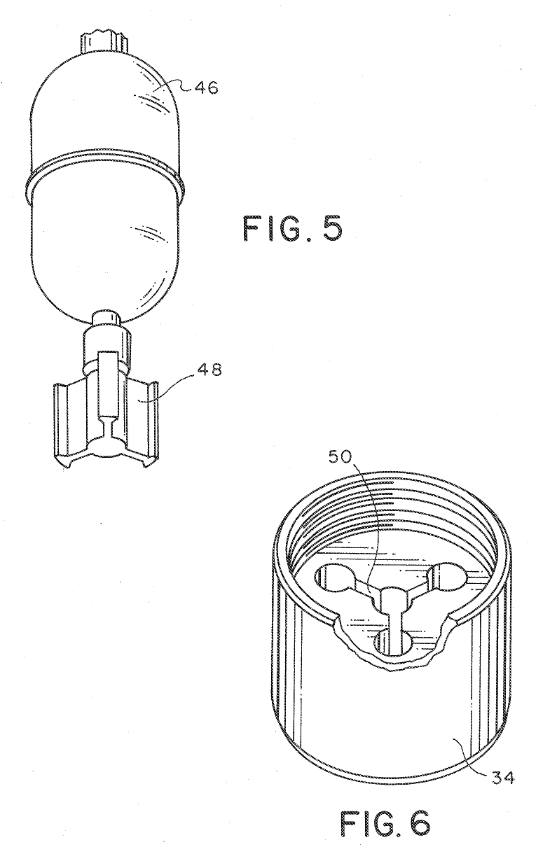

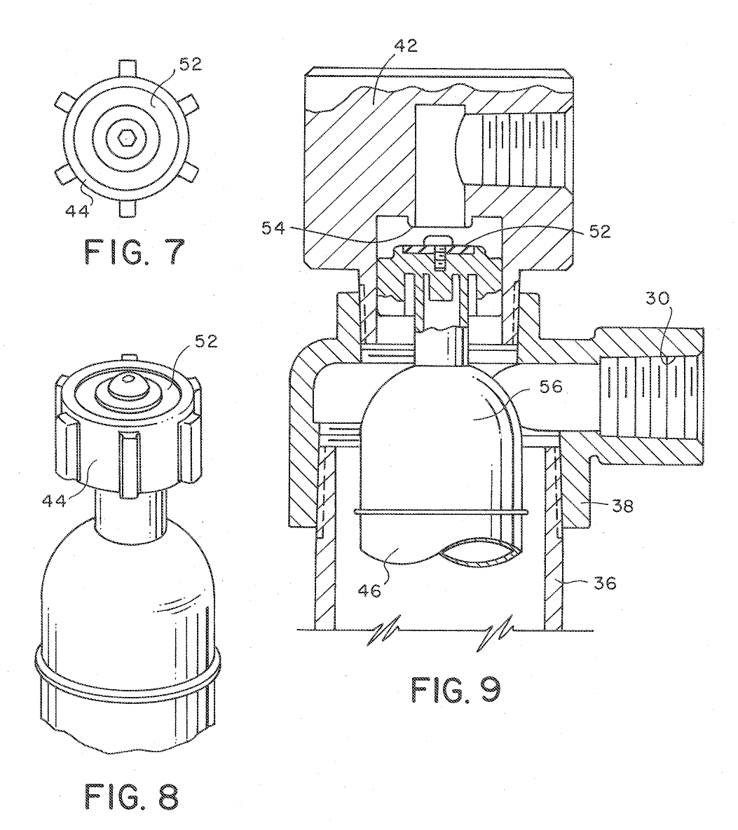

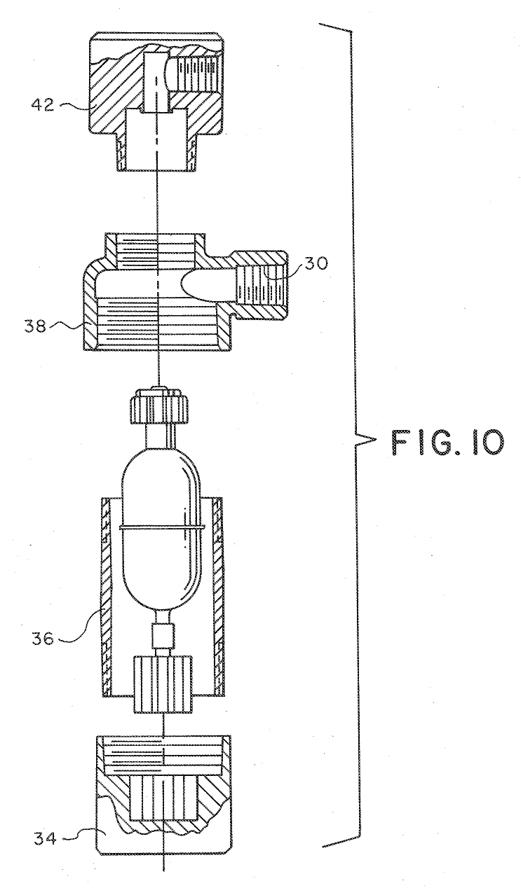

Referring to FIGS. 1-10, where like numerals refer to like and corresponding parts, a separating liquid shut-off 10 is used in an ammonia vapor transfer system 12. System 12 also includes a gasoline-powered vapor transfer pump 14 to move the contents of nurse tank 16 to nurse tank 18.

The separating liquid shut-off 10 includes an inlet 30 to receive a mixed flow of ammonia liquid and vapor. A reservoir 32 is located below the inlet 30, with the reservoir formed of bottom 34, cylinder 36, and top 38. Inlet 30 is formed in top 38.

The function of separating liquid from the vapor is accomplished by a liquid-vapor separator 40 at the top 38 of the reservoir 32. A vapor outlet 42 is located above the separator 40. The liquid-vapor separator 40 is a centrifugal separator, with the inlet 30 disposed in a tangential relationship with an internal separating surface 43 at the top 38 of the reservoir 32.

A float-actuated valve 44 is adapted and arranged to close the vapor outlet 42 if separated liquid in the reservoir 32 rises to a predetermined elevation. Float 46 is constrained for linear motion within the reservoir 32 by a finned anti-rotation element 48 riding in complementary grooves 50 in bottom 34. The swirling flow of ammonia in reservoir 32 would spin the float 46 unless it were prevented from doing so.

Valve 44 is a sealing disk 52 apapted to raise up against and seal an aperture 54 in the outlet 42 in response to liquid in reservoir 32 raising the float 46.

An actuation assembly 56 within the reservoir 32 includes the finned anti-rotation element 48 at the bottom of the actuation assembly 56, the float 46 attached to the top of the anti-rotation element 48, and the valve 44 attached to the top of the float 46.

It will be understood that each of the elements described above, or two or more together, may also find a useful application in other types of constructions differing from the type described above.

While the invention has been illustrated and described as embodied in a particular ammonia vapor transfer system, it is not intended to be limited to the details shown, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

I claim:

1. A separating liquid shut-off for an ammonia vapor transfer system, comprising:
an inlet to receive a mixed flow of ammonia liquid and vapor;
a reservoir below the inlet;
a liquid-vapor separator at the top of the reservoir;
a vapor outlet above the separator; and
a float-actuated valve adapted and arranged to close the vapor outlet if separated liquid in the reservoir rises to a predetermined elevation.

2. The separating liquid shut-off of claim 1 with the liquid-vapor separator being a centrifugal separator, with the inlet disposed in a tangential relationship with an internal separating surface at the top of the reservoir.

3. The separating liquid shut-off of claim 2 with the float being constrained for linear motion within the reservoir.

4. The separating liquid shut-off of claim 3 with an actuation assembly within the reservoir, the actuation assembly having a finned anti-rotation element at the bottom of the actuation assembly, a float attached to the top of the anti-rotation element, and a valve attached to the top of the float.

5. A separating liquid shut-off for an ammonia vapor transfer system, comprising:
an inlet to receive a mixed flow of ammonia liquid and vapor;
a reservoir below the inlet;
a liquid-vapor separator at the top of the reservoir;
a vapor outlet above the separator;
a float-actuated valve adapted and arranged to close the vapor outlet if separated liquid in the reservoir rises to a predetermined elevation;
with the liquid-vapor separator being a centrifugal separator, with the inlet disposed in a tangential relationship with an internal separating surface at the top of the reservoir;
with the float being constrained for linear motion within the reservoir;
with an actuation assembly within the reservoir, the actuation assembly having a finned anti-rotation element at the bottom of the actuation assembly, a float attached to the top of the anti-rotation element, and a valve attached to the top of the float; and
with valve being a sealing disk apapted to raise up against and seal an aperture in the outlet in response to liquid raising the float.
